(19) United States
(12) Patent Application Publication
(10) Pub. No.: US 2003/0108697 A1
(43) Pub. Date: Jun. 12, 2003

(54) Method and installation for producing centrifugally cast, glass-fibre reinforced tubes

(76) Inventors: Borge Carlstrom, Hoganas (SE); Eva Willquist, Lund (SE)

Correspondence Address: DENNISON, SCHULTZ & DOUGHERTY, 1745 JEFFERSON DAVIS HIGHWAY, ARLINGTON, VA, 22202, US

(21) Appl. No.: 10/257,941

(22) PCT Filed: Apr. 26, 2001
(86) PCT No.: PCT/EP01/04736

(30) Foreign Application Priority Data
Apr. 27, 2000 (DE) 100 20 642.5

(51) Int. Cl. B32B 1/08; B29C 41/04

(52) U.S. Cl. 428/34.5; 428/36.91; 264/311; 425/435

(57) ABSTRACT

The invention relates to a method and installation for the purpose of manufacturing centrifuged glass fibre-reinforced synthetic material pipes, wherein liquid curable resin, which can contain a filler, together with glass fibres and additives for the curing process, possibly also with sand, is introduced into a rotating mould. With respect to the mould temperature as the raw materials are introduced, the quantity and type of additives are adapted in a successive manner such that gelling commences in the outer part of the pipe when the last part of the raw materials is introduced. Upon gelling, the temperature is lower in the outer part than in the inner part and gelling only commences in the inner part of the pipe after all of the raw materials have been introduced.

The invention relates to a method and installation for manufacturing centrifuged glass fibre-reinforced synthetic material pipes, wherein liquid, curable resin, which can contain a filler, together with glass fibres and additives for the curing process, possibly also with sand, is introduced into a rotating mould.

WO 00/43185 describes a method of rapidly manufacturing centrifuged, glass fibre-reinforced pipes, wherein the temperature of the mould is at least 40° C.

As it is disclosed in WO 00/43185 the sand layers usually are positioned in the middle of the pipe wall (in the neutral zone). There are, however, such glass fibre synthetic resin pipes having in their outer part sand layers with a low synthetic resin content, e.g. 35% polyester, but in their inner part this amount can increase to 70%. Pipes having larger diameters and nominal pressures are provided with layer thicknesses of the glass fibre layer and the glass fibre polyester layer, respectively, such that the generated heat is not carried away, but a strong temperature increase occurs.

It is the object of the invention to provide a method and installation for manufacturing centrifuged, glass fibre-reinforced pipes, wherein it is also possible to perform a rapid curing process also at a lower mould temperature.

Furthermore, the invention is also to provide manufacturing centrifuged, glass fibre-reinforced pipes having larger diameters and for higher pressures wherein it is prevented that the temperature due to the reaction of the synthetic resin increases too much, curing is effected too rapidly and densification therefore is deteriorated too much.

In accordance with the invention, this object is achieved in the case of a method having the features of claim 1 or 15 and with an installation having the features of claim 16. A centrifuged, glass fibre-reinforced synthetic resin pipe having a plurality of layers consisting of glass fibres, synthetic resin, sand and additives according to the invention is indicated in claim 19.

In the case of the method in accordance with the invention for the purpose of manufacturing centrifuged, glass fibre-reinforced synthetic material pipes, liquid, curable resin, which can contain a filler, together with glass fibres and additives for the curing process, possibly also with sand, is introduced into a rotating mould. With respect to the temperature of the mould as the raw materials are introduced, the quantity and type of the additives are adapted in a successive manner, so that gelling commences in the outer part of the pipe when the last part of the raw materials is introduced. Upon gelling, the temperature in the outer part is lower than in the inner part and the gelling process only commences in the inner part of the pipe after all of the raw materials have been introduced.

Therefore, it has been proven that it is also possible to achieve rapid curing, if the temperature of the mould is less than 40° C. However, it is important that highly reactive polyester resins are used and that the additives of catalysts, accelerators and inhibitors are adapted in a precise manner to suit the temperature of the mould and the wall thickness of the pipes.

In order to achieve rapid curing and effective compaction at the same time, it is important that the additive quantities are changed in a successive manner as the raw materials are introduced. In so doing, it is necessary to ensure that the resin commences to gel precisely at the point when all of the raw materials have been introduced. If gelling commences in the outer part, heat is produced and as a consequence the temperature also rises inside the pipe. In this case, the additives must be adapted in such a manner that the curing process is not performed so rapidly that the compaction is of insufficient quality or the saturation of the glass fibres is inadequate.

Therefore, in the case of one variation of the method, the additives are adjusted such that gelling only commences three minutes after all of the raw materials have been introduced. This serves to ensure uniform distribution of the raw materials in the pipe.

Furthermore, in order to heat up the mould after commencement of gelling in the outer layer of the pipe, warm water at a temperature of at least 50° C. is sprayed on to the mould.

The temperature in the inner part of the pipe can increase to 50° to 70° C. by virtue of the heat development in the outer part. Inhibitors should therefore be used in order to control the reaction in the inner part of the pipe. In the past, the use of inhibitors repeatedly caused problems in the manufacture of glass fibre-reinforced synthetic material pipes. It is important to verify exactly the required quantity, as otherwise the pipes will not be adequately cured. The quantity and type of catalysts must be tailored to suit the quantity of inhibitor.

In an advantageous manner, the quantity of inhibitor can range between 38 and 61% of the quantity which prevents heat development.

Preferably, a more reactive catalyst mixture is used in the outer part of the pipe than in the inner part.

In the case of one advantageous method variation, catalyst pumps are used in such a manner that a catalyst or a catalyst mixture having a lower light-off temperature is used in the outer part of the pipe, wherein the other catalyst or other catalyst mixture is used in the inner part of the pipe.

In case of one method variation, wherein always sand and preferably polyester resin is used as synthetic material, a plurality of sand layers is used which are partitioned into a plurality of sand layers using thermic calculations. The thermic calculations serve the purpose of transferring the heat developed in the glass fibre polyester layers to the sand layers and to prevent the temperature increasing too much. The sand layers advantageously result in an improvement of densification of the glass fibre polyester layers provided below and in a reduction of the polyester resin content. The reduction of the polyester content results in a decrease of the temperature increase in the glass fibre layers.

The enthalpy of the polyester resin is of high importance in the calculations. For non-flexible polyester resins it is in the order of 250 to 370 Joules/gramme. In the case of very flexible resins it is at 150 to 200 Joules/gramme. Below some examples are given for polyester mixtures having a resin enthalpy of 290 Joules/gramme when the raw material temperature is 20° C.:

| glass fibre content (%) | exothermic temperature (° C.) |
|---|---|
| 0 | 181 |
| 30 | 155 |
| 40 | 144 |
| 50 | 121 |
| 60 | 116 |
| sand content (%) | exothermic temperature (° C.) |
| 60 | 116 |
| 70 | 99 |
| 80 | 78 |

When polyester resins having fillers are used, it is appropriate to use a polyester resin having an enthalpy of about 350 Joules/gramme. It is also appropriate to use a filler in the inner pipe wall.

For obtaining a good densification, a fibre length of 75 to 100 mm should be used. Thereby the roving content can be increased to 70%.

The partition of the sand into various layers is to be made in such a manner that no layer except the sand layer of the neutral zone of the pipe wall has a thickness that is larger than 0.0025 of the outer diameter and is not more than 20% of the wall thickness. The sand layers are not to contain roving. When sand is added a surplus of resin should be present. Thereby the sand is flowing very uniformly and covers uneven formations in the roving layers. Thereby the need of cover layer resin is reduced.

Further to the last sand layer a roving layer should be provided as a blocking layer having a thickness of at least 2 mm. Here the glass fibre content should be below 40%.

Preferably the individual layers having a glass fibre-reinforcement should be larger than 0.005 times the outer diameter. In the circumferential direction the layers having a glass fibre reinforcement except the blocking layer have a thickness between 1.5 and 3.5 mm.

For obtaining a good densification the gelling time should be accurately adjusted in the individual layers depending on the injection time.

In the case of an installation in accordance with the invention for the purpose of manufacturing centrifuged, glass fibre-reinforced synthetic material pipes, the raw materials are introduced from an injection machine into a rotating mould. The injection machine can be moved in a fixed position, wherein the centrifugal machines are, however, mounted on a carriage which can be moved in a transverse manner with respect to the injection machine in the same plane. Warm water is used for the purpose of heating up the mould, wherein the spraying devices are disposed in fixed positions and cannot be moved with the moulds, water is collected under each mould in separate collecting basins, which can be moved with the mould, and is conveyed further into a fixed channel.

The invention will be described hereinunder by means of examples and with reference to the drawings, wherein this illustration serves to explain the invention but is not intended to limit the invention by specific description. In the drawings,

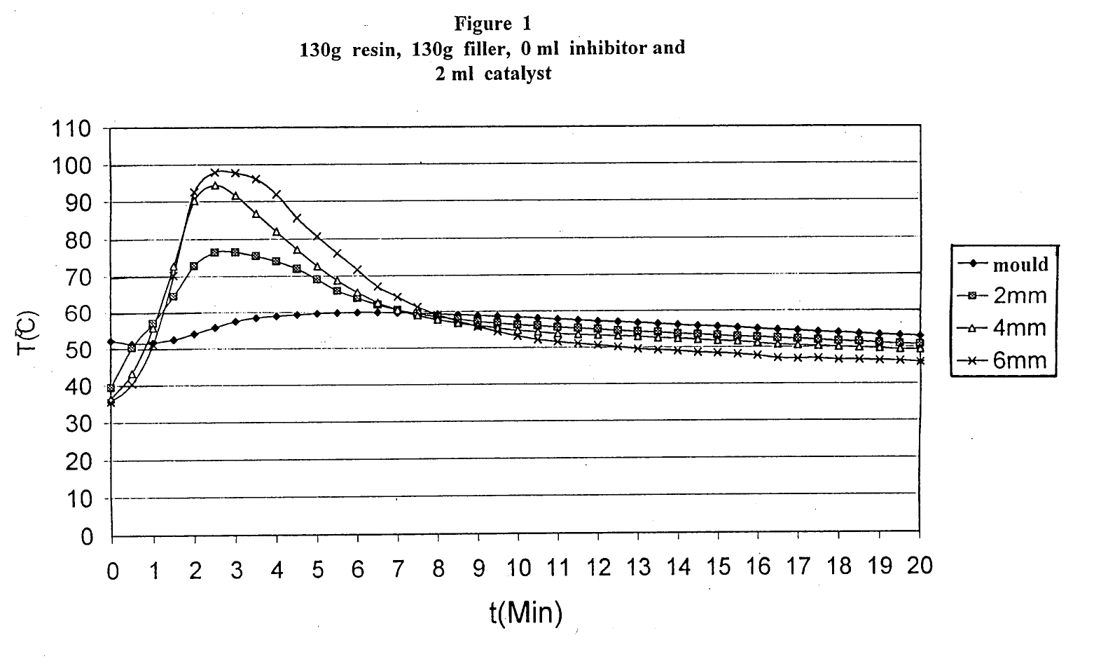

FIGS. 1 to 7 show diagrams illustrating the temperature progression over time for the mould and pipes having different wall thicknesses for different layers and different quantity proportions of inhibitor,

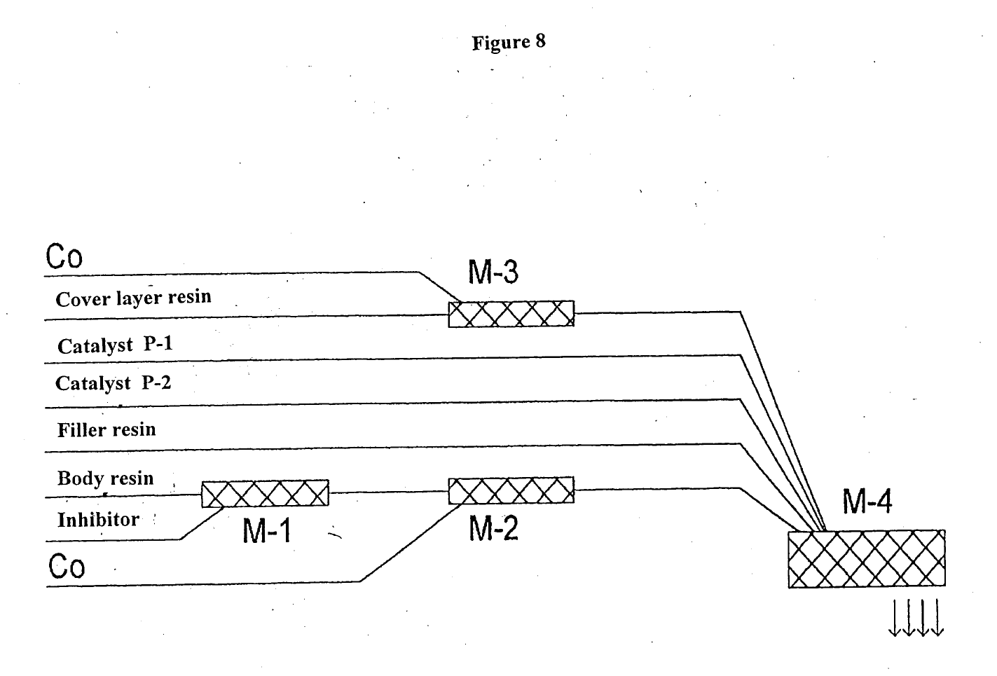

FIG. 8 shows an example of the arrangement of mixers on an injection machine operating according to the method in accordance with the invention, for the purpose of manufacturing centrifuged glass fibre-reinforced synthetic material pipes,

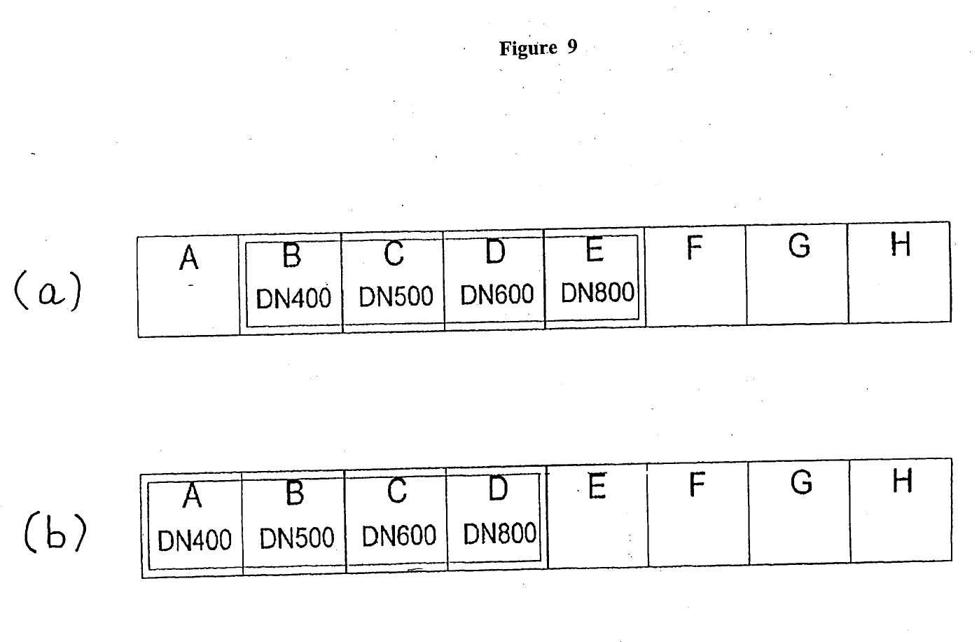

FIG. 9 shows a schematic view of the structure of an installation having processing stations A to H for the purpose of manufacturing centrifuged glass fibre-reinforced synthetic material pipes,

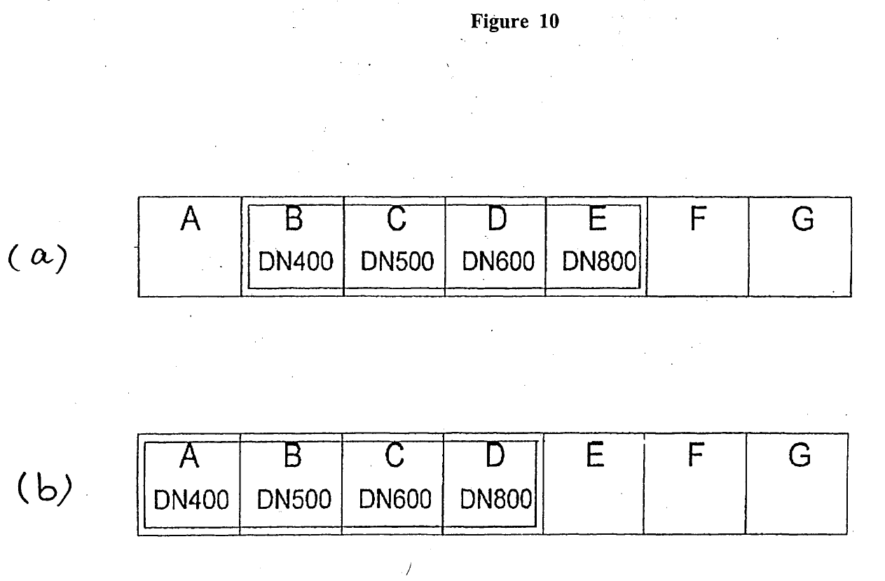

FIG. 10 shows a schematic view of the structure of an installation having processing stations A to G for the purpose of manufacturing centrifuged glass fibre-reinforced synthetic material pipes,

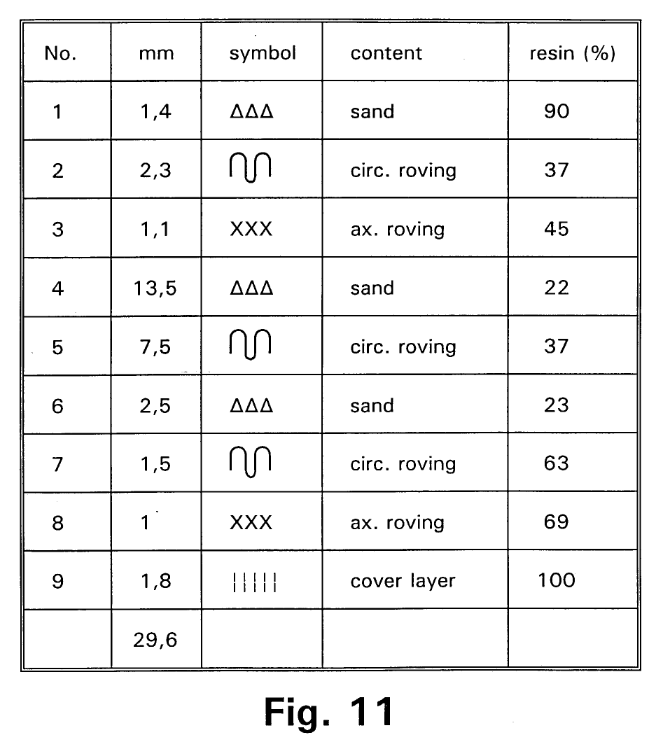

FIGS. 11 to 13 show the structure of pipes having different nominal diameters and provided for different nominal pressures, and

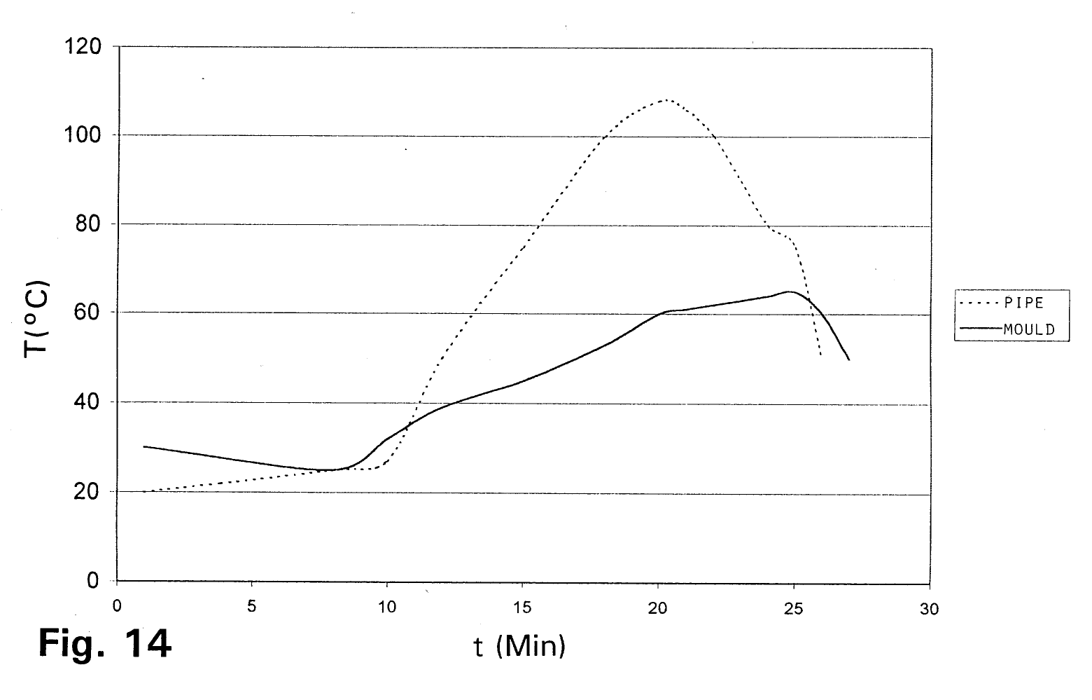

FIG. 14 shows a diagram illustrating the temperature progression over time inside in the pipe and outside on the mould.

FIGS. 1 to 7 illustrate the temperature development in different layers, calculated from the lower part of a heated mould.

FIG. 1 illustrates the progression of the temperature development without inhibitors. The temperature of the mould is 52° C. and gelling occurs at 50° C. after about one minute.

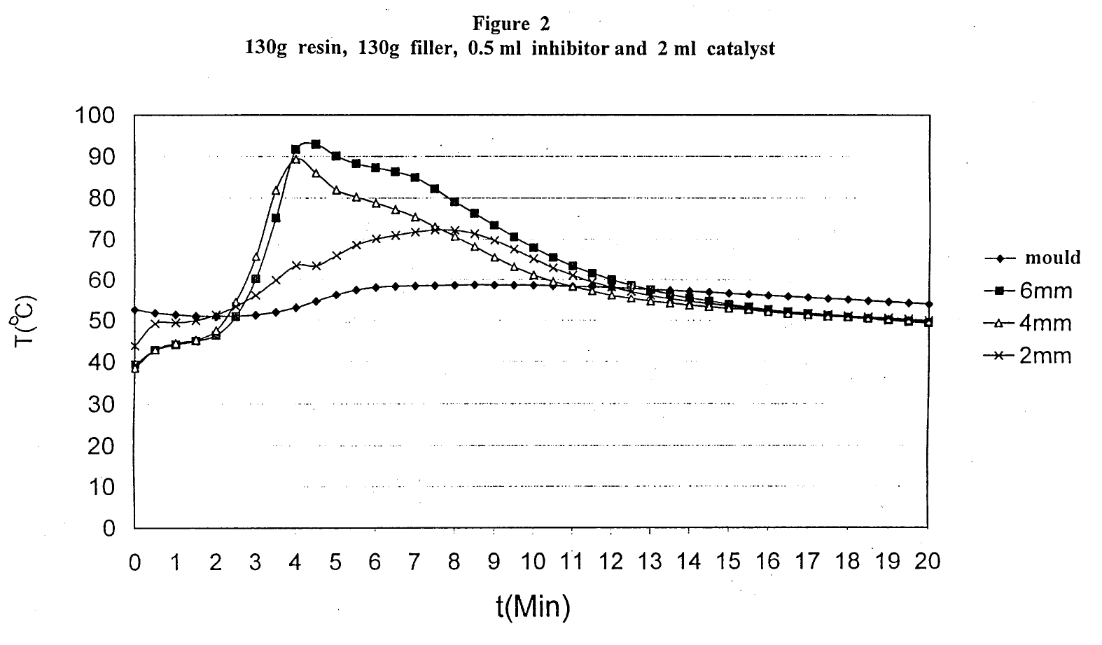

FIG. 2 illustrates that with the use of 0.38% inhibitor, calculated with respect to the quantity of body resin (pure resin), a longer gelling time has been achieved.

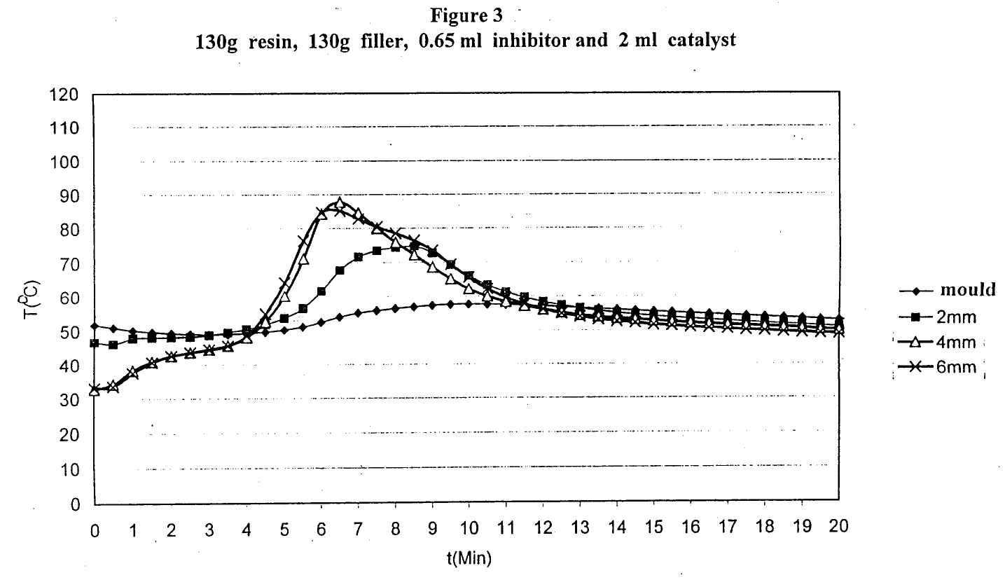

FIG. 3 illustrates that owing to the use of an inhibitor gelling in the upper part only commences after about four minutes.

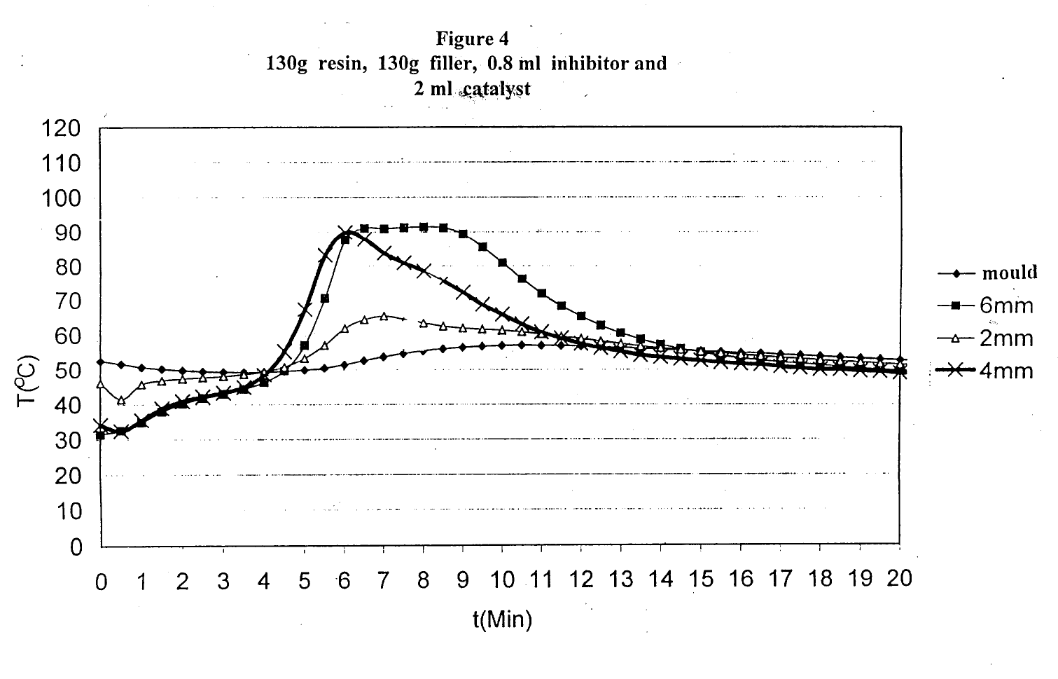

FIG. 4 illustrates that with the use of 0.61% inhibitor, calculated with respect to the quantity of body resin, the gelling time achieved is not longer than in the case of FIG. 3.

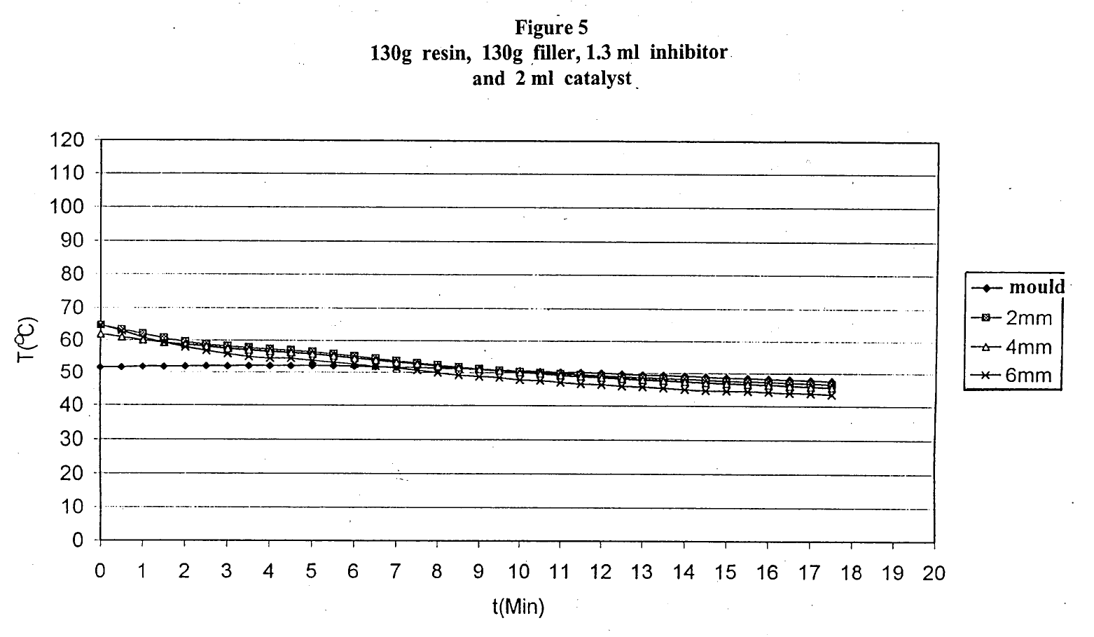

FIG. 5 illustrates that there is no heat development if an excessive quantity of inhibitor is used.

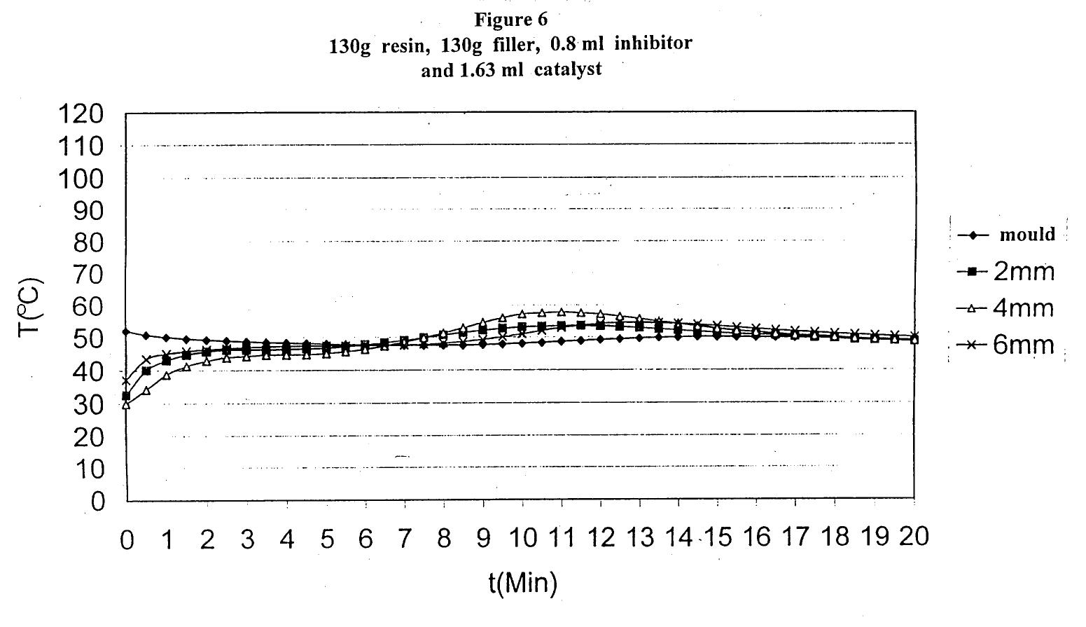

FIG. 6 illustrates a similar reaction if the catalyst quantity is reduced.

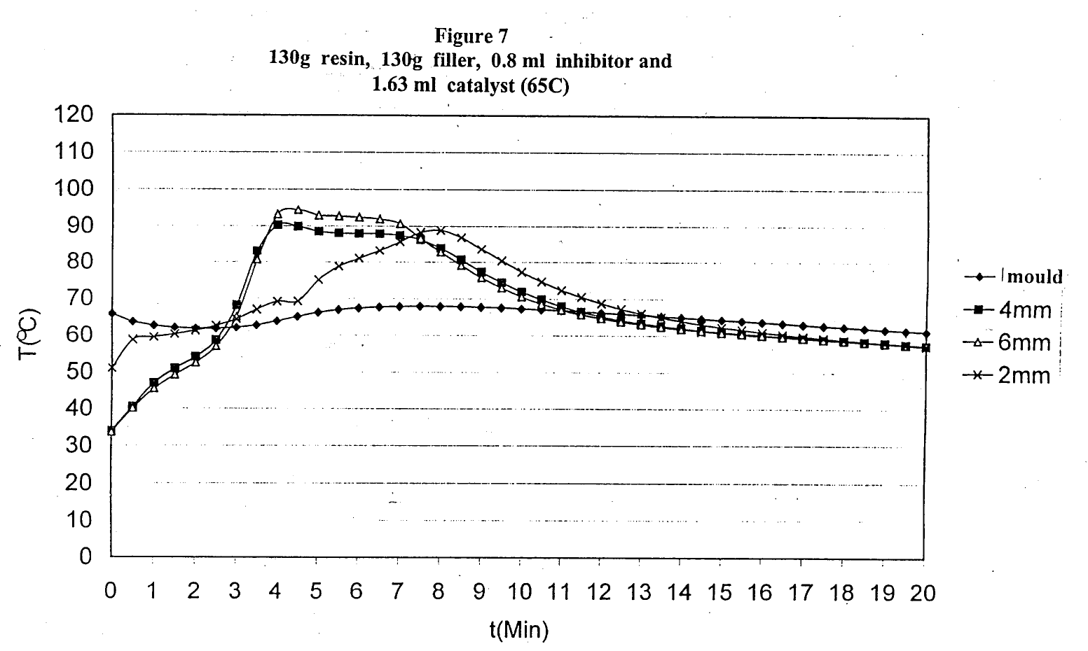

FIG. 7 illustrates that heat development occurs if the temperature of the mould is increased. In practice, this is equivalent to spraying warm water on the mould.

FIG. 8 illustrates the arrangement of the required mixers on an injection machine. M-1 is the mixer at the front, where with the aid of two catalyst pumps P-1 and P-2 catalysts are mixed into the resins. M-2 is the mixer, where accelerators, e.g. Co-accelerators, are mixed into the body resin. M-3 is the mixer, where accelerators are mixed into the liner resin (pure resin as the main component in the cover layer on the inside of the pipe). M-4 is the mixer at the rear in the injection machine, where inhibitors are mixed into the body resin.

FIG. 9 illustrates the structure of an installation having 8 processing stations. FIG. 9(a) illustrates the injection process and FIG. 9(b) illustrates the extraction process.

The following example illustrates the mode of operation of the installation.

### EXAMPLE

The following components are mixed in a filler mixer:

100 parts body resin

0.5 parts inhibitor of 10% butylcatechol in styrene

0.2 parts promoter D (N, N-diethylacetoacetamide)

150 parts CaCO₃-powder.

Co-accelerators having 1% Co are added to the body resin in mixer M-2.

0.5% Co-accelerator is added in mixer M-3.

0.5% inhibitor, consisting of 10% butylcatechol, is added in mixer M-4.

A pipe having DN 800 PN 10 (nominal diameter 800 mm, nominal pressure 9.8 bar) is produced as follows:

The pipe has 7 layers comprising the following structure, calculated externally:

| | |
|---|---|
| 1. | Sand layer |
| 2. | Long fibre reinforcement |
| 3. | Short fibre reinforcement |
| 4. | Sand layer |
| 5. | Long fibre reinforcement |
| 6. | Barrier layer including short fibre reinforcement |
| 7. | Cover layer. |

1.5% catalyst is used in all layers, wherein different ratios of acetone-acetyl-peroxide (AAP) and tertiary butyl-perbenzoate (TBPB) are used as follows:

| Layer | AAP | TBPB | Co in M-2 |
|---|---|---|---|
| 1 | 50% | 50% | 0.5% |
| 2 | 40% | 60% | 0.7% |
| 3 | 30% | 70% | 0.7% |
| 4 | 50% | 50% | 0.8% |
| 5 | 30% | 70% | 0.6% |
| 6 | 25% | 75% | 0.5% |
| 7 | 20% | 80% | — |

AAP is more reactive than TBPB. It has a lower light-off temperature.

Thee injection period is 6 minutes and the mould temperature is 35° C. After the raw materials have been introduced, the carriage conveys the mould to station F in FIG. 9, where after 4 minutes all of the layers have gelatinated and warm water at a temperature of 70° C. is sprayed for 30 seconds.

After 5 minutes in station F, the mould is conveyed to station G and after 4 minutes to station H, where warm water at a temperature of 70° C. is immediately sprayed for a period of 20 seconds. In station H, the extraction process is prepared. After 4 minutes, the mould is conveyed to station D, where the pipe is extracted in a warm state.

Back in position E, the mould is heated to 35° C. and a new pipe having DN 800 is manufactured.

A collecting container for warm or cold water is provided under each mould. In each station, it is possible in fixed positions to spray warm or cold water.

The water from the collecting containers is collected in a fixed channel without separating the cold and warm water and is returned to the water processing installation in a pipe line.

The process of adjusting the resin reaction is performed so rapidly that in the pipe the reaction in the outer part increases to about 70° C. and in the inner part to 90 to 110° C. The process of spraying warm water is intended to stop the lower mould temperature from preventing the reaction in the outer part.

As shown in the illustration of FIG. 9, the use of a plurality of moulds determines the following mode of operation. If the mould DN 600 passes into the injection station E, the mould DN 800 must be in station G, and if the mould DN 500 is located in station E, the mould DN 800 must be in station G. The mould DN 800 is in station H, if the mould DN 400 is in station E. Depending upon the initial temperature of the mould, the heat capacity of the mould and the mould mass on the carriage, it is possible where required to use warm water or cold water in stations F to H.

The eight stations of the installation as shown in FIG. 9 render it possible for the pipes always to be extracted at station D. However, if only seven stations are provided, then the pipe DN 800 must be extracted in station G and the other pipes must be extracted in station C. Station D is then used for the injection process.

In the following the structure of a pipe according to the invention is described as illustrated in FIG. 11. Concerning the calculations it is assumed that the heat developed in the layers No. 1 to 3 is received by the steel mould. Concerning the layers 4 to 8 the generated heat is 5.800 Joules/meter pipe. The heat capacity is 70.6 Joules/° C. and meter pipe which would result in a temperature increase of 82° C. The cover layer resin has an enthalpy of 170 Joules/gramme. With a specific heat of 1.8 Joules/gramme° C. this would result in a temperature increase of 94° C. if no heat would get lost. The maximum temperature would be about 102° C. with admissible temperature values toward 110° C. The indication “circ.roving” refers to the roving orientation mainly in the circumferential direction. The roving length is 60 mm.

When polyester resins having filler are used these should have an enthalpy of 350 Joules. It is also appropriate to use filler in the inner pipe wall, see layers No. 4 to 6 in FIG. 11.

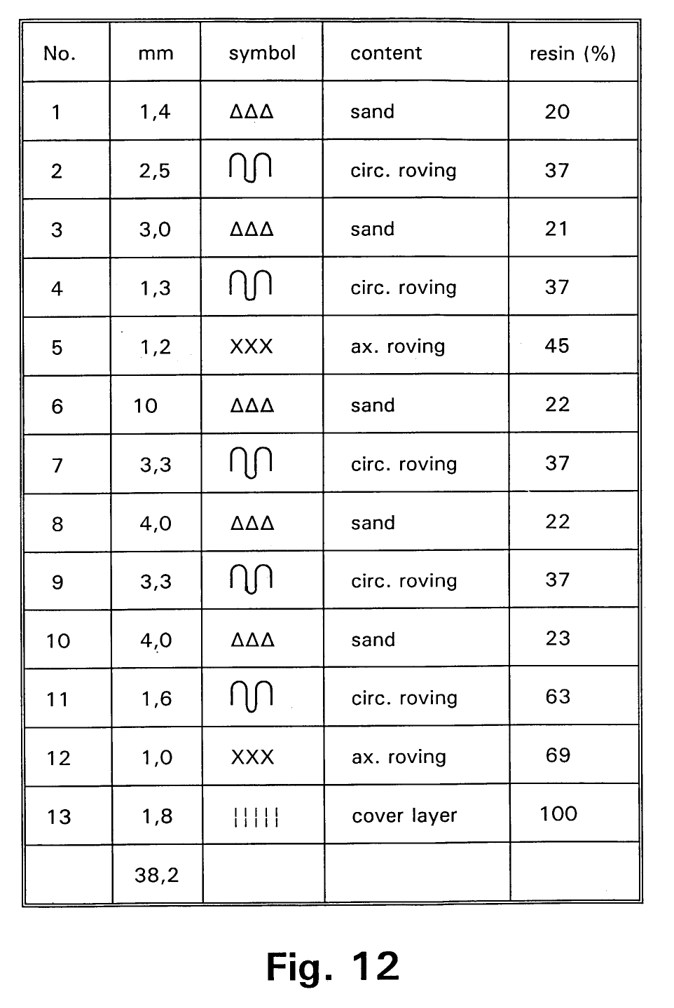

In FIG. 12 the structure of a second example of a pipe according to the invention is illustrated. The pipe is a pipe having plural layers DN 2.000 (nominal width 2.000 mm), PN 16 (nominal pressure 15.7 bar), SN 10.000 (nominal stiffness 10.000 N/m²). The roving length is 60 mm.

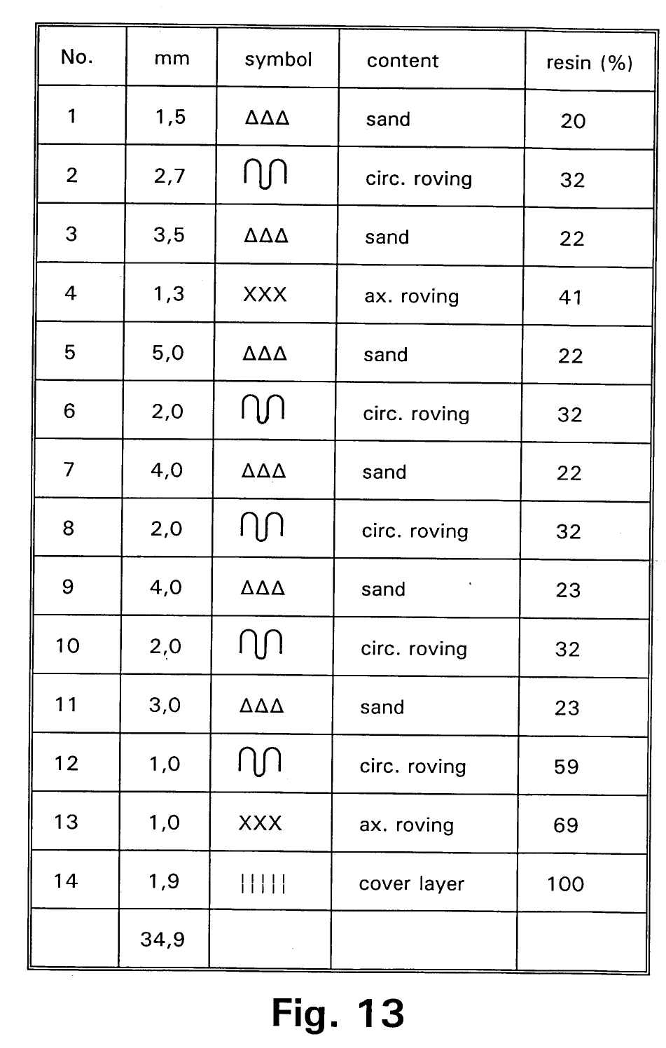

The structure of a third example of a pipe according to the invention is illustrated in FIG. 13. The pipe is a pipe having plural layers DN 2.400 (nominal width 2.400 mm), PN 10 (nominal pressure 9.8 bar), SN 5.000 (nominal stiffness 5.000 N/m²). The roving length is 100 mm.

As mentioned the gelling time in the individual layers has to be precisely adjusted depending on the injection time. The pipe illustrated in FIG. 13 needs an injection time of 23 to be at least 23 minutes at room temperature, if the mould and the raw materials are at room temperature. The injection time for layer No. 2 is 2.5 minutes. This means that the gelling time for these layers is at least 20.5 minutes. Similarly the calculation has to be made for each layer. Basing on laboratory tests the amounts of additive have to be calculated for each layer again.

FIG. 14 illustrates the result of temperature measurements in the interior of the pipe and outside on the mould. The measurement results are in good agreement with the calculations.

1. Method of manufacturing centrifuged glass fibre-reinforced synthetic material pipes, wherein liquid curable resin, which can contain a filler, together with glass fibres and additives for the curing process, possibly also with sand, is introduced into a rotating mould, characterised in that
with respect to the mould temperature as the raw materials are introduced, the quantity and type of additives are adapted in a successive manner, so that gelling commences in the outer part of the pipe when the last part of the raw materials is introduced,
upon gelling the temperature is lower in the outer part than in the inner part, and
the gelling only commences in the inner part of the pipe after all of the raw materials have been introduced.

2. Method according to claim 1, characterised in that gelling only commences in the outer part at least three minutes after all of the raw materials have been introduced.

3. Method according to claim 1 or 2, characterised in that warm water at a temperature of at least 50° C. is sprayed on to the mould after gelling has commenced in the outer layer of the pipe.

4. Method according to any one of the claims 1 to 3, characterised in that an inhibitor is used in a quantity which is between 38% and 61% of the quantity which prevents heat development.

5. Method according to any one of the claims 1 to 4, characterised in that a more reactive catalyst mixture is used in the outer part of the pipe than in the inner part of the pipe.

6. Method according to any one of the claims 1 to 5, characterised in that the inhibitor is added in the feeder in one of the mixers.

7. Method according to any one of the claims 1 to 6, characterised in that an accelerator is added to the body resin in the second mixer (M-2) at the front in the feeder.

8. Method according to any one of the claims 1 to 7, characterised in that the accelerator is added to the liner resin in the third mixer (M-3) at the front.

9. Method according to any one of the claims 1 to 8, characterised in that the inhibitor is added to the body resin at the rear in the mixer (M-4).

10. Method according to any one of the claims 1 to 9, wherein two catalyst pumps are used, characterised in that in one pump a catalyst or a catalyst mixture having a low light-off temperature is used in the outer part of the pipe and the other is used in the inner part of the pipe.

11. Method of manufacturing centrifuged glass fibre-reinforced synthetic material pipes, wherein liquid curable resin, which can contain a filler, together with glass fibres, sand and additives for the curing process, is introduced into a rotating mould, with respect to the mould temperature as the raw materials are introduced, the quantity and type of additives are adapted in a successive manner, so that the gelling commences in the outer part of the pipe when the last part of the raw materials is introduced,
characterised in that
the sand amount, which is necessary for obtaining the stiffness, is partitioned to a plurality of layers so that all glass fibre layers except the blocking layer are positioned between the sand layers in which the roving content is increased by pressurising the sand layers effected by the centrifugal force.

12. Method according to claim 11, characterised in that the individual sand layers except the sand layer in the middle of the pipe wall (neutral zone) are not larger than 15% of the wall thickness of the pipe.

13. Method according to claim 11 or 12, characterised in that the individual sand layers, except the sand layer in the neutral zone, are not larger than 0.0025 times the outer diameter.

14. Method according to any one of the claims 11 to 13, characterised in that the individual layers having a glass fibre-reinforcement are not larger than 0.005 times the outer diameter.

15. Method according to any one of the claims 11 to 14, characterised in that the layers having glass fibre-reinforcement in the circumferential direction except the blocking layer are less than 1.5 mm and not more than 3.5 mm.

16. Installation for the purpose of manufacturing centrifuged glass fibre-reinforced synthetic material pipes, wherein
the raw materials are introduced from an injection machine into a rotating mould,
the injection machine can be moved in a fixed position,
the centrifugal machines are, however, mounted on a carriage which can be moved in a transverse manner with respect to the injection machine in the same plane,
warm water is used of the purpose of heating up the mould,
characterised in that the spraying devices are disposed in fixed positions and cannot be moved with the moulds and
water is collected under each mould in separate collecting basins, which can be moved with the mould, and said water is conveyed further into a fixed channel.

17. Installation according to claim 16, having an injection machine for the purpose of feeding raw materials into the moulds, wherein a mixer (M-1) is provided at the front for the purpose of supplying catalysts, characterised in that a mixer (M-4) is also provided at the rear in the injection machine for the purpose of introducing further additives into the body resin.

18. Installation according to claim 17, characterised in that at least one further mixer (M-2 or M-3) is provided at the front in the injection machine.

19. Centrifuged glass fibre-reinforced synthetic material pipe, comprising a plurality of layers consisting of glass fibres, curable resin, which can contain a filler, glass fibres, sand and additives, characterised in that the sand amount, which is necessary for obtaining the stiffness, is partitioned to a plurality of layers so that all glass fibre layers except the blocking layer are positioned between the sand layers in which the roving content is increased by pressurising the sand layers effected by the centrifugal force.

20. Plastic pipe according to claim 19, characterised in that the individual sand layers except the sand layer in the middle of the pipe wall (neutral zone) are not larger than 15% of the wall thickness of the pipe.

21. Plastic pipe according to claim 19 or 20, characterised in that the individual sand layers, except the sand layer in the neutral zone, are not larger than 0.0025 times the outer diameter.

22. Plastic pipe according to any one of the claims 19 to 21, characterised in that the individual layers having a glass fibre-reinforcement are not larger than 0.005 times the outer diameter.

23. Plastic pipe according to any one of the claims 19 to 22, characterised in that the layers having glass fibre-reinforcement in the circumferential direction except the blocking layer are less than 1.5 mm and not more than 3.5 mm.
